(19) United States
(12) Patent Application Publication
(10) Pub. No.: US 2015/0057962 A1
(43) Pub. Date: Feb. 26, 2015

(54) REAGENT KIT AND MEASUREMENT SOFTWARE SERVER

(71) Applicant: USHIO DENKI KABUSHIKI KAISHA, Tokyo (JP)

(72) Inventor: Kinichi MORITA, Tokyo (JP)

(21) Appl. No.: 14/464,816

(22) Filed: Aug. 21, 2014

(30) Foreign Application Priority Data
Aug. 26, 2013 (JP) 2013-174582

(51) Int. Cl. G01N 21/01

(52) U.S. Cl. CPC G01N 21/01; G01N 2021/0162
USPC 702/123

(57) ABSTRACT

Provided is a reagent kit that includes: a reagent to be used together with a measuring device in measurement of an optical characteristic of a sample; one or more reagent containers containing therein the reagent; and an access information indicator. The access information indicator is indicative of access information that allows a client to gain access to a measurement software server. The client is operated upon the measurement of the optical characteristic. The measurement software server is a server on which measurement software is uploaded. The reagent kit is provided for analysis of the sample through the measurement of the optical characteristic. The access information contains provider identification information that allows for identification of a reagent provider. The reagent provider is a provider of the reagent kit.

### CROSS REFERENCE TO RELATED APPLICATIONS

This application claims the benefit of Japanese Priority Patent Application JP2013-174582 filed on Aug. 26, 2013, the entire contents of which are incorporated herein by reference.

### BACKGROUND

The invention relates to a reagent kit provided for analysis of a sample performed through measurement of optical characteristics of the sample with use of a reagent and a measuring device, and a measurement software server used upon such optical measurement.

Analyzing a sample through measurement of optical properties of the sample, such as through absorption spectrophotometry, colorimetric determination, fluorescence or phosphorescence measurement, or chemiluminescence measurement, has been actively carried out as one of the principal approaches to perform material analysis. For example, reference is made to International Publication No. WO2009/057659. In such optical material analysis, a reagent is often used as an auxiliary material. For example, the reagent may be used when performing measurement through mixing a sample with a liquid phase reagent and diluting the mixed resultant, when performing identification or quantitation of a sample through causing reaction of a sample with a reagent and examining a change in optical properties occurring as a result of the reaction, or when performing fluorescence measurement through labeling a sample with a fluorescent reagent. As used herein, and throughout this disclosure, the term “reagent” refers broadly to any auxiliary material used upon performing analysis of a sample.

In general, calibration curve data is necessary when performing quantitation or identification of a sample through such optical approaches. A calibration curve is a graph that shows a relationship of a standard sample whose factors such as amount and property are known versus measurement data obtained on that standard sample. Applying the calibration curve data to an actual measurement result allows for determination of a component included in a sample or of an amount of particular component in a sample in relation to a standard value defined in the calibration curve data, for example. Obviously, when performing analysis that uses a reagent, calibration curve data is created in advance in connection with characteristics of the reagent. The term “calibration curve” may sometimes be used when performing quantitation on an absolute value basis.

On the other hand, a measuring device used when performing such optical analysis of a sample is provided with a detector for detecting intensity of light derived from a sample. The detector has so-called sensitivity characteristics, and data indicative of a relationship of an output value obtained from the detector versus actual light intensity (i.e., sensitivity characteristic data) is therefore necessary. Sensitivity of the detector is often dependent on a wavelength, and it is therefore also necessary to take the wavelength dependency into account when performing the optical analysis.

For optical analysis of a sample as described above, an output of the detector is converted to light intensity, and the thus-obtained light intensity is applied to the calibration curve data to perform quantitation or identification of the sample. In identification, there sometimes is a case where a sample in question is identified as containing a target substance, when light intensity is equal to or greater (or equal to or less) than a certain value. In such a case, data on the certain value (threshold) is also necessary.

It is desirable to provide a reagent kit and a measurement software server capable of allowing optical analysis of a sample in which a reagent is used to be performed in a simple manner.

A reagent kit according to an embodiment of the invention includes: a reagent to be used together with a measuring device in measurement of an optical characteristic of a sample; one or more reagent containers containing therein the reagent; and an access information indicator indicative of access information that allows a client to gain access to a measurement software server, in which the client is operated upon the measurement of the optical characteristic, and the measurement software server is a server on which measurement software is uploaded. The reagent kit is provided for analysis of the sample through the measurement of the optical characteristic, and the access information contains provider identification information that allows for identification of a reagent provider. The reagent provider is a provider of the reagent kit.

Advantageously, the access information may comprise product serial information. Advantageously, the access information indicator may comprise an information code readable by a reader provided in the client. Advantageously, the information code may comprise a two-dimensional symbol optically readable by the reader. Advantageously, the access information indicator may be provided on the one or more reagent containers or an outer packaging, and the outer packaging contains therein the one or more reagent containers.

A measurement software server according to an embodiment of the analysis of a sample performed through measurement of an optical characteristic of the sample with use of a reagent and a measuring device, and the client is operated upon the measurement of the optical characteristic. The storage section stores therein provider identification information that is included in the access information and allows for identification of a reagent provider, and information that indicates that the access by the client through the access information is made. The reagent provider is a provider of the reagent kit.

Advantageously, the storage section stores therein, as a database file, information in a form of database that includes the provider identification information and information indicative of date and time at which the measurement software is downloaded or executed by the access.

According to the reagent kit and the measurement software server in the above-described embodiments of the invention, it is possible to perform optical analysis of a sample in which a reagent is used in a simple manner.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the invention.

FIGS. 1A and 1B each schematically illustrate a reagent kit according to an embodiment of the invention.

FIG. 2 illustrates a content of access information and an outline of a measurement software server according to an embodiment.

FIG. 3 schematically illustrates a method of analyzing a sample using the reagent kit according to the example embodiment.

FIG. 4 schematically illustrates uploading of measurement software and payment of usage fee for the measurement software in the reagent kit according to the example embodiment illustrated in FIGS. 1A to 3.

FIG. 5 schematically illustrates a database file for managing the measurement software.

FIGS. 6A and 6B each schematically illustrate a reagent kit according to another embodiment.

### DETAILED DESCRIPTION

Some embodiments of the invention are described in detail below with reference to the accompanying drawings. First, a description is given of a reagent kit according to an embodiment of the invention.

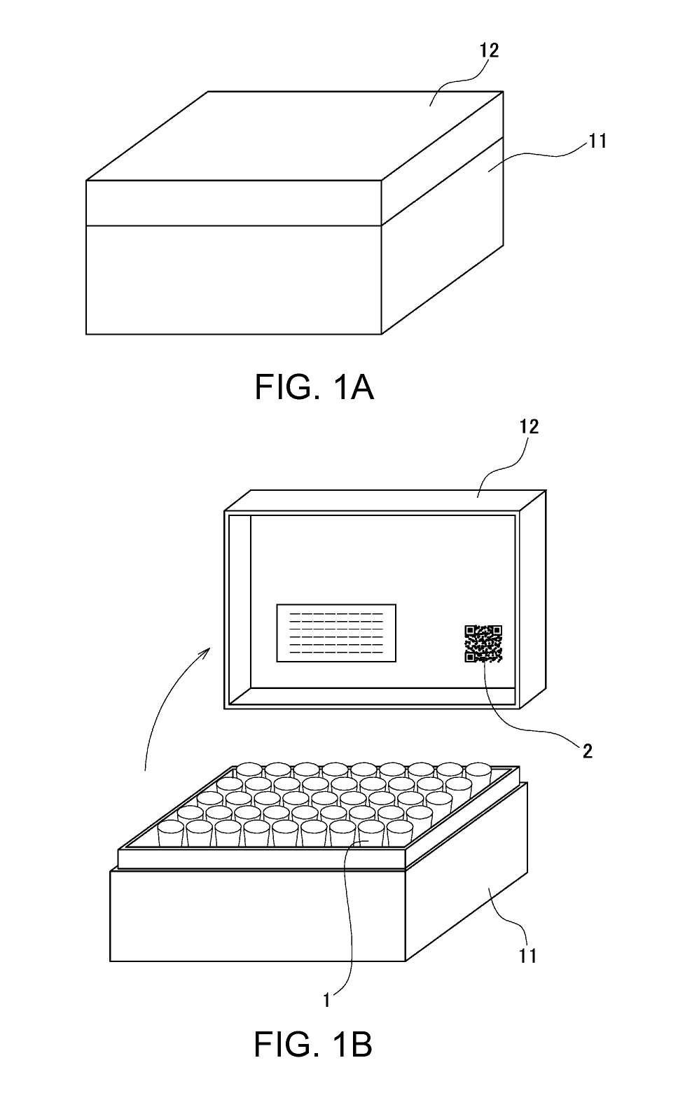

FIGS. 1A and 1B are each a schematic perspective view of a reagent kit according to an embodiment of the invention. The reagent kit is provided for measuring optical characteristics of a sample using a reagent and a measuring device to thereby analyze that sample, typically through the sale by a reagent manufacturer who manufactures that reagent.

The reagent kit includes a reagent contained in a reagent container 1. In the present embodiment, the reagent container 1 may be an elongated container having a shape of an inverted cone, often referred to as a “Finntip” available under the registered trademark of Thermo Fisher Scientific located in Waltham, Mass. In one embodiment where the reagent container 1 employs the Finntip, the reagent container 1 may be made of a plastic such as polyethylene, polypropylene, or polystyrene.

Referring to FIGS. 1A and 1B, the reagent kit according to the present embodiment is provided with a reagent, a plurality of reagent containers 1 each containing therein the reagent, and an outer packaging containing therein the plurality of reagent containers 1. The outer packaging is provided with a packaging body 11 and a cover 12. FIG. 1A illustrates a state where the cover 12 is closed whereas FIG. 1B illustrates a state where the cover 12 is open.

The packaging body 11 includes an unillustrated container holder having a plurality of holes each of which is adapted to a cross-sectional shape of the reagent container 1. Each of the reagent containers 1 is held by the container holder while being inserted in the container holder.

According to the present embodiment, the reagent kit includes an access information indicator 2. The access information indicator 2 may be located at a particular portion on an inner surface of the outer packaging in the present embodiment. In one specific embodiment, the access information indicator 2 may be located at a particular portion on an inner surface of the cover 12.

In the present embodiment, the access information indicator 2 may be in a form of a sticker attached to the inner surface of the cover 12. The sticker may be obtained through converting access information to a “QR code” (registered trademark of DENSO WAVE Incorporated located in Aichi, Japan) and printing the QR code on stickers. Hence, in the present embodiment, an information code in a form of the QR code may serve as the access information indicated by the access information indicator 2.

The access information indicated by the access information indicator 2 is information that causes a client computer (in the following, may be referred to as “client 4”) to gain access to a particular server and causes the client 4 to download or execute measurement software. In the present embodiment, the access information may cause the client 4 to download the measurement software and execute the downloaded measurement software, and may thus contain information that allows the client 4 to download the measurement software. As used herein, the term “particular server” refers to any server in which software, used when analyzing a sample through optical measurement with use of a reagent, is uploaded, and such a server is referred to as a “measurement software server” in the following description.

Because the access information indicator 2 is the indication of the QR code, it is necessary that the client 4 be equipped with a camera capable of taking an image of the QR code and be installed therein with a program that allows decoding of the QR code (in the following, referred to as a “decode program”). Non-limiting examples of such a client 4 may include a tablet computer and a smartphone each of which may be commercially-available. Other non-limiting examples of the client 4 may include a laptop and a desktop computer, to which a camera such as a web camera is connected and in which software for reading the QR code is installed.

The client 4 as described above may be operated by a person (measurer) who uses a provided reagent to perform optical measurement of a sample. The term “measurer” is intended to encompass a helper such as an assistant. The measurer takes an image of the QR code using a camera and executes the decode program installed in the client 4 to gain access to the measurement software server and thus to download the measurement software.

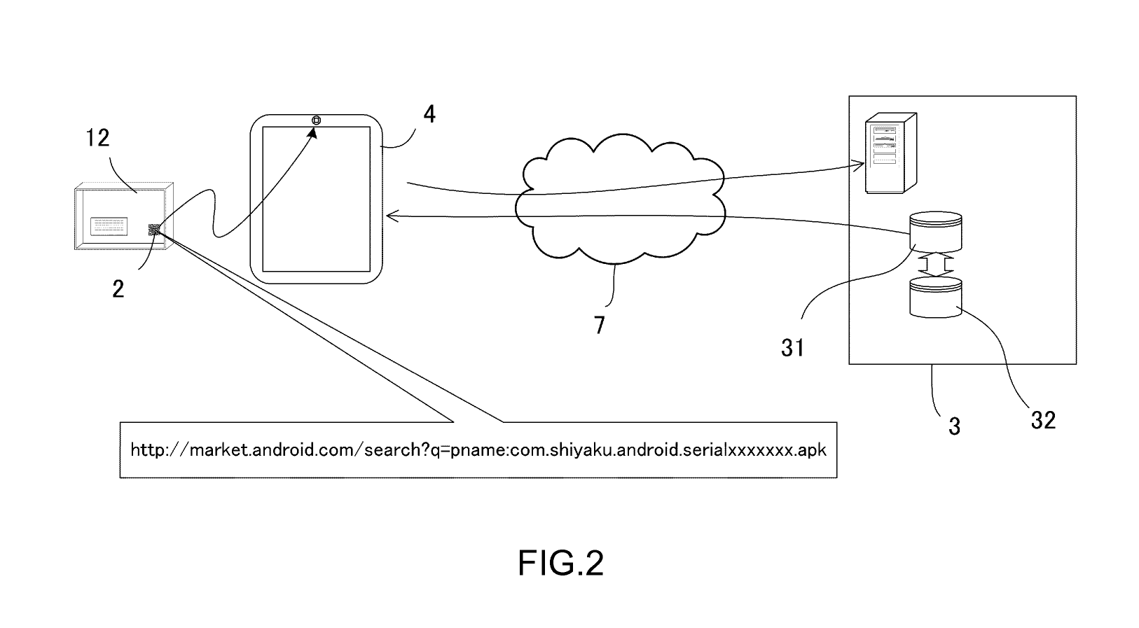

FIG. 2 illustrates a content of the access information and an outline of measurement software server according to one embodiment.

The measurement software server 3 can take various forms, one of which measurer to download the measurement software. In either case, both the example configurations described before work in the same basic way. In the following, a description is given with reference to the latter case as an example embodiment.

For example, a service, directed to a device such as a tablet computer or a smartphone, is widely recognized in which a developed application program is uploadable freely (with a requirement to pass a certain examination) and a user is allowed to download such application program with or without payment. Non-limiting examples of the service may include “Google Play” (registered trademark of Google Inc. located in Mountain View, Calif.) store available from Google Inc. and “App Store” (registered trademark of Apple Inc. located in Cupertino, Calif.) available from Apple Inc. In the following, such a service is referred to as an “application download service”.

The reagent kit according to the present embodiment utilizes the application download service. FIG. 2 illustrates an example of the access information to be decoded by the client 4. FIG. 2 is based on one embodiment where the measurement software is uploaded on the Google Play store, and a measurer gains access to the Google Play store to download the measurement software. In the Google Play store, downloading is made possible through accessing a page in the Google Play store. On the other hand, Uniform Resource Locator (URL) for direct downloading is also offered by the Google Play store. The access information indicator 2 illustrated in FIG. 2 may be obtained by converting the URL into the QR code.

In one specific embodiment, a code on the left of “search?q=pname:” denotes the name of a software to be downloaded, and a distribution file 31 of the measurement software specified by the URL may be stored in a storage section of the measurement software server 3. The code may be executed on an Android (registered trademark of Google Inc.) OS, which thereby allows the measurement software having that name to be downloaded onto the client 4 through the Internet 7. In this embodiment, the URL hence serves as the access information.

What is important in the present embodiment is that provider identification information, which allows for identification of a reagent provider who has provided the reagent kit, is contained in the access information. In the present embodiment, the measurement software may have the name based on identification information of a product (which may be a product serial number) of a reagent manufacturer who has provided the reagent kit, thereby making it possible to identify the reagent provider. Each reagent manufacturer typically attaches a product serial number based on its own unique rule, meaning that a possibility, in which a certain product serial number of a certain reagent manufacture “A” is the same as a certain product serial number of another reagent manufacture “B”, is not zero in theory but is next to zero. Hence, preparing in advance a correspondence table representing a product serial number versus a reagent manufacturer who employs that product serial number allows for identification of the reagent manufacturer only by acquiring the product serial number. In the present embodiment, the software name may be thus based on the product serial number, and the access information identifier 2 may be indicative of the access information that allows downloading to be performed through specifying the software name.

The distribution file 31, to be downloaded through reading the access information indicator 2 that may be in a form of the QR code, may typically be a self-extracting file, and may be stored in a storage section of the client 4. The storage section may include an external memory such as, but not limited to, an internal hard disk drive, an SD memory card (registered trademark), or the like. The measurement software may be decompressed on the client 4 to be extracted thereon.

The extracted measurement software includes a measurement program and calibration curve data. The measurement program allows a measurement result to be obtained by being executed, and the calibration curve data is used upon execution of the measurement program. The calibration curve data is a data file associated with the measurement program, and reference is made thereto upon execution of the measurement program.

The measurement program may be executed on the client 4, or may be executed on a measuring device. In the following, a description is given of an example embodiment where the measurement program is executed on the client 4.

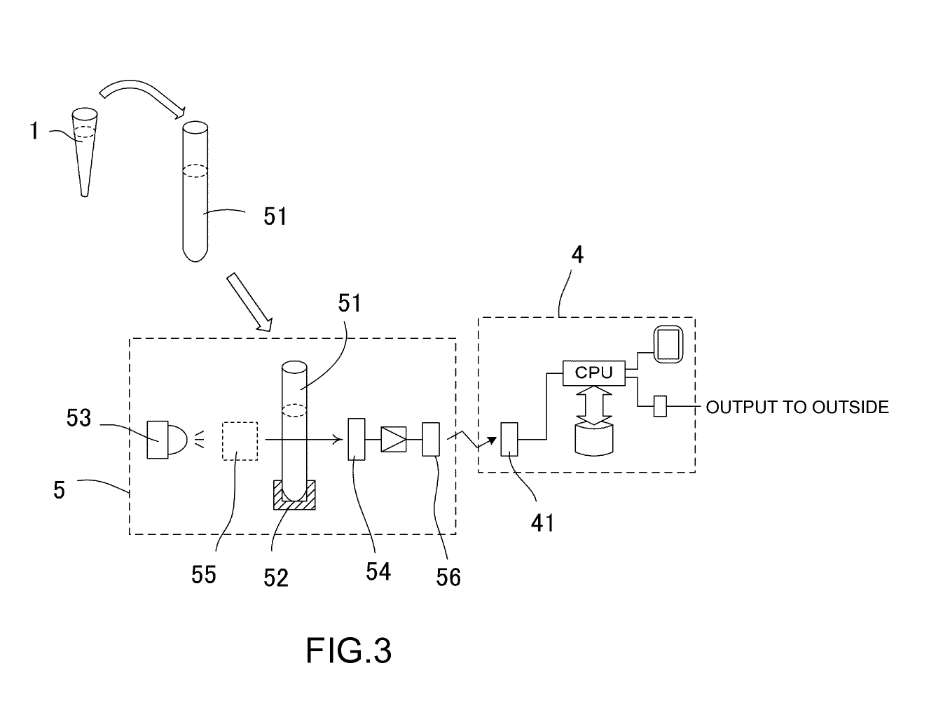

FIG. 3 schematically illustrates a method of analyzing a sample using the reagent kit according to one embodiment. Although the reagent kit according to any embodiment of the invention is applicable to various optical measurements, a description is given with reference to FIG. 3 of an example embodiment where absorption spectrophotometry is performed to analyze a material. In this embodiment, a reagent may be a liquid phase reagent which is to be taken out from the reagent container 1 to be placed in a measurement container 51 followed by mixing and dissolving of a sample. As illustrated in FIG. 1B, the reagent container 1 in the reagent kit according to one embodiment may be the Finntip, to which Finnpipette (registered trademark of Thermo Fisher Scientific) may be used to take out a predetermined amount of reagent from the Finntip. The reagent taken out from the Finntip may then be injected into the measurement container 51 to be used for analysis. The measurement container 51 may be a test tube, a reservoir tube, or the like.

The measuring device 5 is provided with a holder 52 for folding the measurement container 51. The holder 52 holds the measurement container 51 at a predetermined position relative to a member such as a light source 53 or a detector 54. The measuring device 5 includes the light source 53 configured to apply light to the sample inside the measurement container 51 held by the holder 52, and the detector 54 configured to detect light having been transmitted through the inside of the measurement container 51. Between the light source 53 and the measurement container 51 is any optical system 55 which may be disposed on an as-needed basis. The optical system 55 may encompass a filter by which the sample is irradiated with light having been selected in wavelength by the filter. The reagent container 1 may be mounted to the holder 52 to be used for the analysis directly.

For example, in one embodiment where the measuring device 5 is directed to absorption spectrophotometry, a configuration may be employed in which the light source 53 is a white light source and the detector 54 is an RGB sensor. In an alternative embodiment in which the measuring device 5 is directed to measurement of an intensity of fluorescence through labeling of a sample with a fluorescent reagent and excitation of laser light, a laser light source may be used for the light source 53.

The measuring device 5 is provided with a transmitter 56 for sending an output of the detector 54. The measuring device 5 in the present embodiment may be configured to send the output through a wireless communication, and the transmitter 56 thus serves as a wireless transmitter. The client 4, in which the measurement program is executed that allows a measurement result to be obtained from the output of the detector 54, is provided with a receiver 41 compatible with the transmitter 56 of the measuring device 5. For example, the transmitter 56 and the receiver 41 may perform a Bluetooth (registered trademark of Bluetooth SIG located in Overland Park, Kans.) communication, an infrared communication, or any other suitable communication method.

As described above, the measurement program and the calibration curve data are installed on the client 4. When performing analysis of a sample using the measuring device 5, the reagent is placed in the measurement container 51 and is mixed with the sample to dissolve the sample, following which the measurement container 51 is mounted to the holder 52. Thereafter, the light source 53 is lit to allow the detector 54 to detect transmission light derived from the measurement container 51. The output obtained from the detector 54 (in the following, referred to as an output value) is sent from the transmitter 56 to the client 4, and the client 4 receives the output value through the receiver 41. The measurement program is being executed in advance on the client 4. The measurement program causes the received output value to be temporarily held in a memory in a form of a variable.

The measuring device 5 may perform, on an as-needed basis, detection of an intensity of reference light besides the intensity detection of the light (measurement light) derived from the sample. For example, the measurement container 51, in which a reagent is placed with no inclusion of the sample, may be set to the holder 52, and an intensity of transmission light under such a situation is detected likewise. Alternatively, an output of the detector 54 under a situation where holder 52 is not mounted with the measurement container 51 may be treated as the detection value of the reference light. The measurement program may also cause the detection value of the reference light obtained in any of such circumstances to be temporarily held in the memory in the form of the variable.

The measurement program causes the detection value to be read from the memory (variable), and causes a relative intensity of the measurement light to be calculated by comparing the read detection value with the detection value of the reference light described above, or by comparing the read detection value with a previously-stored reference value. Thereafter, the thus-obtained intensity is applied to the calibration curve data to perform analysis, such as identification or quantitation, of a sample. For example, the detection value read from the memory (variable) may be compared with the calibration curve data to measure concentration of a particular component in the sample. A result of the measurement may be displayed on a display of the client 4, or may be output to the outside through an interface such as Universal Serial Bus (USB).

In the analysis of the sample on the basis of the optical measurement as described above, a change in target substance, a content of the analysis, or the like may require measurement to be performed using a different reagent while using the same measuring device 5. In such a case, a measurer acquires the reagent kit in which that different reagent is provided.

The measurer then likewise reads the access information indicator 2 which may be provided on the cover 12 of the outer packaging using the camera of the client 4, and thus gains access to the measurement software server 3 to download the measurement software of the corresponding reagent onto the client 4. After downloading, the measurer places the client 4 in a state in which the downloaded measurement program is being executed, and puts a reagent and a sample in the measurement container 51 likewise to perform the measurement. Each output obtained by the detector 54 is retrieved by the client 4 through a communication such as the wireless communication, and the measurement program causes a detection result to be applied to the calibration curve data to obtain a measurement result.

In this manner, each time a different reagent is acquired to perform analysis of a sample, the access information indicator 2 on the corresponding outer packaging is read, and the measurement software of the corresponding reagent is downloaded and used. Here, the measurement software has been downloaded on the client 4 for each of the reagents. Hence, it is preferable that measures be taken in order to prevent a measurer from performing erroneous use. For example, in one embodiment, icons each utilizing the corresponding name of reagent may be created, and desired one of the icons may be clicked to open up a holder corresponding thereto of the desired measurement software.

Next, a description is given of a technical significance of the access information indicator 2 in the reagent kit according to the example embodiment described above,

First, problems associated with general approaches of optical analysis are discussed below. In analysis of a sample using optical approaches, characteristic data (device characteristic data) of a measuring device is necessary in addition to calibration curve data, and it is in many cases difficult to perform various measurements in a simple manner. When performing analysis through the use of a reagent and a general-purpose measuring device such as a light detector or a spectrometer, an output of the detector is converted to light intensity in accordance with the device characteristic data provided by a measuring device manufacturer, and the thus-converted light intensity is applied to the previously-created calibration curve data to perform quantitation or identification of a sample.

Because the calibration curve data depends on each reagent, the calibration curve data is often provided by a reagent manufacturer. For performing a large volume of analysis or performing the analysis efficiently, it is necessary to automate the application of the light intensity to the calibration curve data through the use of a program. In this case, a measurer creates in advance a measurement program on the basis of the calibration curve data provided from the manufacturer, and inputs each light intensity obtained by a measuring device to obtain a measurement result. It is necessary that the measurement program be capable of obtaining a measurement result in which the device characteristic data is taken into consideration and calibration is made in accordance with the characteristics of the measuring device.

However, creating the measurement program in advance by a measurer is troublesome. Also, it is necessary to recreate the program when there is a change in target substance or a reagent, because the calibration curve data is subjected to change accordingly. In most cases, diversion of software is not possible even when general-purpose hardware is available as hardware (such as a light detector or a spectrometer).

Despite such circumstances, optical analysis of a sample using a reagent is at the same time the rapidly growing field. Various reagents have been developed for the purpose of quantitation or identification of various target substances and actively utilized for research and product development purposes. One example is a PCR method in which amplification of DNA is achieved through Polymerase Chain Reaction (PCR), as one of the approaches of gene analysis. The PCR method has been widely used in that selective amplification is possible of only the desired DNA fragment in the desired DNA molecule among long DNA molecules like the human genome. In this case, for example, reaction of nucleic acid and a dye reagent is conducted to dye the nucleic acid, following which optical measurement is performed to determine the presence of PCR amplification. The optical measurement is, in many cases, based on the absorption spectrophotometry of a sample dyed using the dye reagent.

Another example of the optical measurement in which a sample is dyed using the dye reagent may be an approach of causing reaction of a sample and a fluorescent reagent for fluorescent observation. As described above, various approaches of analyzing samples with the use of various reagents have been developed, and applications of the reagent-based optical analysis of a sample are spreading, such as in the fields of genetic research and research and development of new pharmaceuticals and new materials.

The present embodiment therefore aims to reduce a burden of a measurer and allow for analysis of various materials using various reagents freely in a simple manner, to thereby make a contribution to a further development in the field of optical analysis of a sample in which a reagent is used.

Next, a description is given of some examples of technical measures for uploading of the measurement software and payment of usage fee for the measurement software.

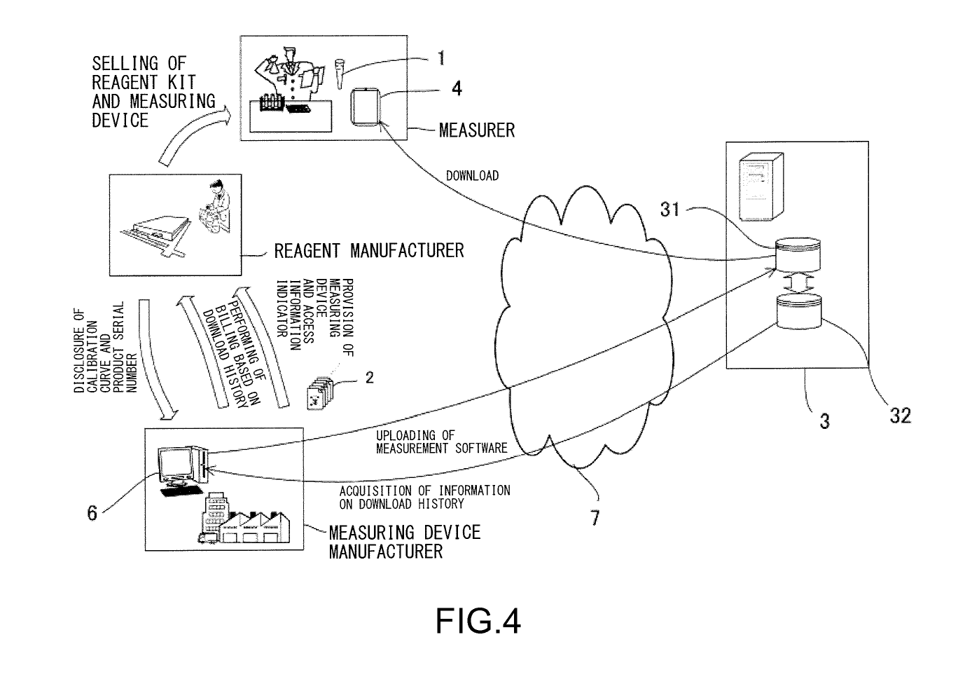

FIG. 4 schematically illustrates uploading of the measurement software and payment of usage fee for the measurement software in the reagent kit according to the example embodiment illustrated in FIGS. 1A to 3.

As described above, the calibration curve data in which characteristics of the measuring device 5 and characteristics of the reagent are both taken into consideration is necessary for the measurement software. For the measurement program, it is necessary to apply the detection value to the calibration curve data on the basis of a content of analysis. Hence, it is difficult for a reagent manufacturer to create the measurement software. In the present embodiment, in view of the difficulty in creating the measurement software by a reagent manufacturer, a measuring device manufacturer creates the measurement software and uploads the created measurement software.

Referring to FIG. 4, the measuring device manufacturer receives characteristic data of a reagent from a reagent manufacturer, and creates the calibration curve data and the measurement program while taking the characteristics of the measuring device 5 supplied by the measuring device manufacturer itself into consideration. Thereafter, the measuring device manufacturer uploads the thus-created measurement software onto the measurement software server 3. In one embodiment where the Google Play store is employed, the measuring device manufacturer completes developer registration and account acquisition beforehand, and then uploads the measurement software after having completed preparation of English-language documents, electronic signature of the distribution file (an executable file to be downloaded), etc.

Also, the measuring device manufacturer receives disclosure of a product serial number of the reagent from the reagent manufacturer. Further, the measuring device manufacturer defines a file name of an executable file for downloading of the created measurement software on the basis of the disclosed product serial number, and creates the access information (access code) that contains that file name. Then, the measuring device manufacturer converts the access information into an image of the QR code, and provides the reagent manufacturer with an image file of that QR code. The reagent manufacturer prints the provided image file on stickers, and may attach the sticker onto the inner surface of the cover 12 of the outer packaging to complete the reagent kit including the access information indicator 2 in a form of the QR code. Thereafter, the reagent manufacturer provides the reagent kit to a user (measurer). In one embodiment, the measuring device manufacturer may print the QR code on stickers, and may deliver the predetermined number of stickers (for example, the number exceeding the number of shipments of the reagent kits) each printed with the QR code to the reagent manufacturer.

The measuring device manufacturer creates the measurement software for each of two or more types of reagent kits brought to market by one reagent manufacture, and uploads the created pieces of measurement software. Also, the measuring device manufacture may receive supply of characteristic data and a product serial number of a reagent from each of different reagent manufacturers, and create the measurement software for each of those reagent kits belonging to the respective different reagent manufacturers to upload the created pieces of measurement software. Hence, the measuring device manufacturer creates the measurement software for each of the numerous reagent kits that are likely to be used in the measuring device 5 sold by the measuring device manufacturer itself.

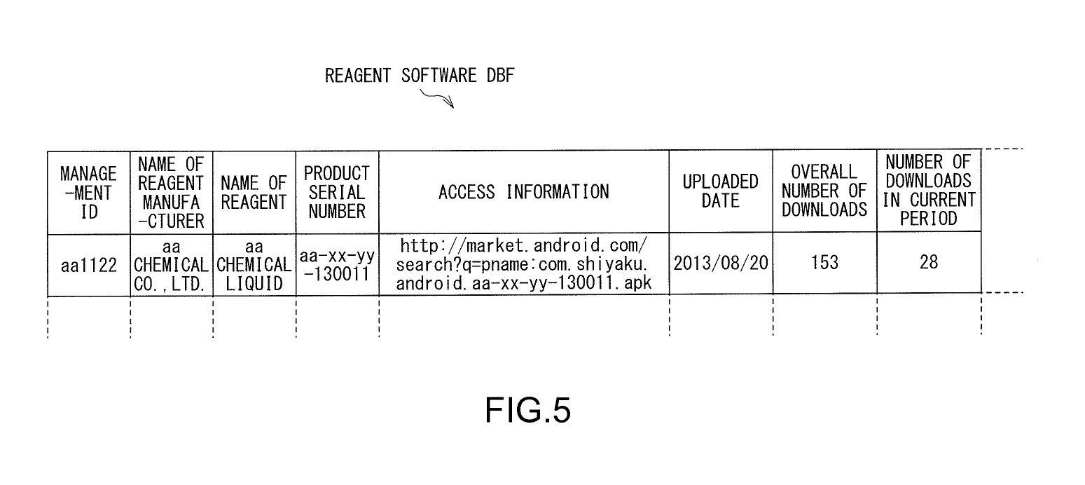

In the reagent kit according to the present embodiment, competing of the product serial numbers may be checked. As illustrated in FIG. 4, a management computer 6 may be provided as a computer operated by a person in charge of the measuring device manufacturer. A storage section of the management computer 6 has a database file for managing the measurement software. FIG. 5 schematically illustrates a database file (hereinafter referred to as “reagent software DBF”) for managing the measurement software.

Referring to FIG. 5, the reagent software DBF may be a database file in which a plurality of records are stored. The records may be related to fields such as “management ID”, “name of reagent manufacturer”, “name of reagent”, “product serial number”, “access information”, “uploaded date”, “overall number of downloads”, and “number of downloads in current period”. The “access information” is original information used upon conversion into the QR code, and may be the code shown in FIG. 2. The “overall number of downloads” is the total number of downloads of the measurement software specified by that access information.

Upon a request for software creation made by a certain reagent manufacturer with the provision of characteristic data and a product serial number of a reagent to be marketed, a person in charge of the measuring device manufacturer searches the reagent software DBF using the provided product serial number to check whether or not the identical product serial number is present. When there is no identical product serial number, the person in charge creates the access information indicator 2 (the sticker printed with the QR code in the example embodiment described above) indicative of the access information that is based on that product serial number. Further, the person in charge creates the measurement software and uploads the created measurement software, before recording a value of each field illustrated in FIG. 5 to update the reagent software DBF.

Although it is highly unlikely that the identical product serial number is attached to different reagents supplied from the same reagent manufacturer, it is likely by coincidence that the identical product serial number is attached to different reagents supplied from the respective different reagent manufacturers. In such a case, because it is possible for the person in charge to know the competing of the product serial numbers from the registration of the identical product serial number upon the search of the reagent software DBF described above, the person in charge makes an appropriate modification to the competing product serial numbers to allow for discrimination between the competing product serial numbers. In one embodiment, a branch number or a branch symbol such as “-1” or “-A” may be affixed to the end of the product serial number, and the product serial number may be incorporated in the access information thereafter.

Such a method as described above allows for the uploading onto the measurement software server 3 of the measurement software dedicated to each of the reagent kits supplied from the respective reagent manufacturers, and the accessing made through the access information indicator 2 provided in the reagent kit for the downloading of the measurement software from the measurement software server 3. This eliminates the necessity for the measurer to program the measurement program and/or to create the calibration curve data on its own account. Also, this makes it possible for the reagent manufacturer to disclose only the characteristic data of the reagent and to be released from a troublesome work of creating the software.

Further, this makes it possible for the measuring device manufacturer to eliminate the necessity of disclosing the characteristic data of its own measuring device 5, as well as to promote sales of the measuring device 5. In other words, for example, this makes it possible for the measuring device manufacture to make a proposal to the reagent manufacturer on selling its measuring device 5 and the reagent kit as a set, or to make a proposal to the reagent manufacturer on undertaking creation of the software for the reagent kit and on allowing free downloading for users if the reagent manufacture sells its reagent kit together with the measuring device 5 of the measuring device manufacture as a set.

In addition, this makes it possible for the reagent manufacturer to estimate the amount of each of the reagents, manufactured and sold by the reagent manufacturer, actually used. Typically, reagents are manufactured and sold by a reagent manufacturer and are then delivered to measurers through distributers including wholesaler. In many cases, reagent manufacturers are aware of shipping rates therefrom but are unaware as to the extent of actual usage of the sold reagents. The reagent kit and the measurement software server according to the respective example embodiments allow for understanding of status of usage of reagents in a form of the number of downloads of the measurement software. Hence, it is possible for the reagent manufacturer to know the frequently-used reagents among various reagents manufactured and sold by the reagent manufacturer itself, and to utilize the outcome for development of new products, etc.

In the present embodiment, the reagent manufacturer may bear costs associated with the creation of the measurement software eventually. In other words, request for the payment of creation fee for the measurement software may be eventually made from the measuring device manufacture to the reagent manufacturer. In one embodiment, the fee may be charged based on the number of downloads of the measurement software from the measurement software server 3. In the following, description is given of technical measures for charging the fee according to one embodiment.

Referring to FIG. 4, the measurement software server 3 is provided with a database file (hereinafter referred to as “DL history DBF”) 32 in which the number of downloads of each measurement software is recorded. In one embodiment where the measurement software server 3 is based on the Google Play store described above, the DL history DBF 32 may be a data file linked to a server that provides a developer page. In an alternative embodiment, an FTP server may include a log recording file that may serve as the DL history DBF 32.

As illustrated in FIG. 4, the management computer 6 gains access to the measurement software server 3 (or a data server linked thereto) and opens up the DL history DBF 32 to acquire data on the number of downloads of each measurement software. The thus-acquired data is recorded on the reagent software DBF on the management computer 6. In other words, a file name (the name of the uploaded distribution file) same as that of the acquired data has been registered on the reagent software DBF, meaning that the data may be acquired from the DL history DBF 32 regularly (for example, once a month) and the data may be recorded in the field named “number of downloads in current period” that belongs to the file name same as that of the acquired data.

The data on the number of downloads thus acquired is counted for each of the reagent manufacturers, and request for the payment of the usage fee may be made from the measuring device manufacturer to the reagent manufacturer on the basis of the outcome. The unit price per download may vary from one reagent kit to another. In other words, the number of downloads of the measurement software is large for the reagent that has achieved a large number of sales, whereas the number of downloads is small for the less-sold reagent kit. Nevertheless, a burden of creating the measurement software, uploading the measurement software, etc., is more or less the same regardless of the number of downloads. Hence, in one embodiment, the usage fee may be charged on the basis of the unit price based on the number of downloads.

Also, the request for the payment of the fee from the measuring device manufacturer to the reagent manufacturer may be made based on a period of time starting on the date of uploading. For example, in one embodiment, the usage fee may be charged for the downloads performed during a predetermined period from the uploading date, and the usage fee may not be charged for the downloads performed after the elapse of that period. In an alternative embodiment, the usage fee may not be charged for the downloads performed during a predetermined period from the uploading date, and the usage fee may be charged for the downloads performed after the elapse of that period.

In the example embodiment described above, the product serial number may typically include a production lot number. Typically, the measurement software is recreated for the reagent kit belonging to a different production lot, because characteristics of the reagent belonging to the different production lot become different and the calibration curve is subjected to change accordingly. In other words, the reagent manufacturer provides, for each production lot, the measuring device manufacturer with the characteristic data of the reagent and the product serial number that contains the production lot number of the corresponding production lot. Then, the measuring device manufacturer uploads the measurement software of the corresponding production lot, and provides the reagent manufacturer with the predetermined number of access information indicators 2 (the QR code-printed stickers in the example embodiment described above) that are based on the corresponding product serial number. In an alternative embodiment, when there is no change in characteristics of the reagents between the production lots, the measurement software may not be recreated even when a change is made to the production lot. In such an alternative embodiment, the access information indicator 2 provided for the previous production lot is used as it is, and a measurer downloads the measurement software using that access information indicator 2 to use the measurement software.

Incidentally, it is desirable that the attention be paid for one embodiment where the measurement software is uploaded for each production lot and the usage fee of the measurement software is charged depending on a period from the uploading date as described above. For example, if a contract is made between the measuring device manufacturer and the reagent manufacturer where the usage fee is free of charge during a predetermined period from the uploading date of the measurement software and is subjected to charge after the elapse of the period, the measurement software would be so handled that other different pieces of measurement software are constantly uploaded due to the fact that the name of the measurement software is changed to a different name for each production lot, which means that the predetermined period set forth in the contract will be unexpired forever (i.e., the usage fee will be free of charge forever). In a case of a contract where the usage fee is subjected to charge during the predetermined period, the charged period will be unexpired forever.

To avoid such circumstances, it is desirable that the charge of usage fee of measurement software for an additional production lot of a certain reagent be based on the uploading date of the measurement software corresponding to the initial production lot of that reagent. Hence, in one embodiment, the measurement software for the additional production lot may be recorded in association with the measurement software for the initial production lot. For example, in one embodiment, the reagent software database DBF may be provided with a field for identifying whether the reagent belongs to the initial production lot or the additional production lot, and information used for the association of ID, etc., of the measurement software corresponding to the initial production lot may be recorded when the reagent belongs to the additional production lot.

In the reagent kit according to the example embodiment described above, the reagent kit is provided with the access information indicator 2, and the measurement software is downloadable by gaining access to the measurement software server 3 through the access information indicator 2. Further, analysis of a sample is performable through the optical measurement that uses the downloaded measurement software and the measuring device 5. This makes it possible to eliminate the necessity for a measurer to program the measurement program and/or to create the calibration curve data. Hence, it is possible to reduce a burden of the measurer and allow for analysis of various materials using various reagents freely in a simple manner. Consequently, it is possible to make a contribution to a further development in the field of optical analysis of a sample in which a reagent is used.

Also, the access information indicated by the access information indicator 2 contains the information that allows for identification of a reagent manufacturer. This makes it possible to identify the reagent manufacturer of the provided reagent kit from the access information, when certain measurement software is downloaded. Hence, it is possible to make a request for payment of creation fee of the measurement software easily.

The identification information of the reagent manufacturer may be based on the product serial number. This makes it possible to eliminate the necessity of attaching a management number of the measurement software separately, and thus allows for easier management. However, this does not exclude that a unique management number may be attached without diverting the product serial number. In such an embodiment, it is desirable that a correspondence table, in which the management number and the reagent manufacturer of the reagent kit to which the measurement software managed by the corresponding management number are associated with each other (such as a database file), be provided to manage the management numbers.

It is sufficient for the storage section in the measurement software server 3 to store therein the information indicating that the measurement software is downloaded in response to the access from the client 4 and the provider identification information corresponding to the access information used upon that downloading, and the number of downloads within a predetermined period may not be stored therein. One reason is that the number of downloads may be counted by a separate section through acquiring information from the storage section, in one embodiment.

Further, containing the product serial number in the access information is also advantageous in that a check function is made possible in the event of an erroneous indication. Typically, a product serial number is indicated on a product in the intended way, separately from the access information indicator 2 described above. The product serial number may be printed on the outer packaging or indicated on an outer surface of the reagent container 1 as is. Under such circumstances, when erroneous production of the access information indicator 2 by the measuring device manufacturer or erroneous attachment of the access information indicator 2, used for a different reagent kit, by the reagent manufacturer is occurred, a measurer may consequently use the measurement software different from the intended measurement software, which results in erroneous measurement. To address such errors, the access information (the URL in the example embodiment described above) displayed on the client 4 may be checked upon accessing the measurement software server 3, or a file name of a downloaded file may be checked to confirm whether or not the product serial number contained in the access information differs from the proper product serial number. Hence, it is possible to prevent the erroneous measurement from occurring due to the usage of the erroneous measurement software.

The access information indicator 2 may be provided on the inner surface of the cover 12 of the outer packaging, making it possible to reduce the possibility that the access information is lost. The present embodiment is therefore high in convenience in this regard. The access information indicator 2 may be printed on a piece of paper and the paper may be sealed inside the outer packaging. However, this may cause unable access to the measurement software server 3 if the paper is lost or discarded. In the present embodiment, the reagent containers 1 are held inside the outer packaging, preventing disposal of the outer packaging until all the reagent containers 1 are used up, and thus making it possible to gain access to the measurement software server 3 and download the measurement software at any time by reading the access information indicator 2 on the inner surface of the cover 12.

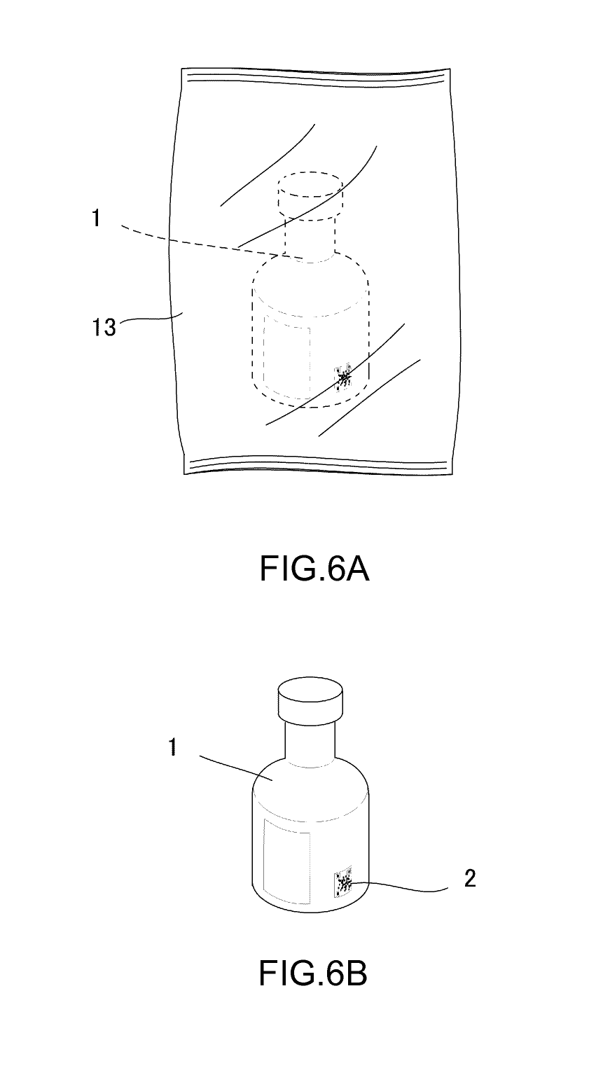

Next, a description is given with reference to FIGS. 6A and 6B of an alternative configuration of the access information indicator 2. FIGS. 6A and 6B each schematically illustrate a reagent kit according to another embodiment.

The reagent kit according to the present embodiment illustrated in FIGS. 6A and 6B is also provided with a reagent and the reagent container 1 containing therein the reagent. A lid of the reagent container 1 is hermitically sealed, and the reagent container 1 may be provided with a sticker adhered thereto, or may be covered with a heat-shrinkable film, such as polypropylene, closely attached thereto on an as-needed basis.

Also, in the present embodiment, the reagent container 1 is contained in an individual packaging 13. The individual packaging 13 has an opening subjected to hermitic sealing, and inside of the individual packaging 13 may be deaerated under reduced pressure on an as-needed basis. Information on a content of a reagent, information on a reagent manufacturer, and so forth are indicated on a surface such as an outer surface of the reagent container 1 or an outer surface of the individual packaging 13. FIG. 6A illustrates the reagent kit as a whole, and FIG. 6B illustrates the reagent container 1 removed from the individual packaging 13.

In the present embodiment, the access information indicator 2 may be located at a particular portion on the outer surface of the individual packaging 13. In one specific embodiment, the access information indicator 2 may be in a form of a sticker printed with the QR code and attached to the outer surface of the reagent container 1. Providing the access information indicator 2 on the reagent container 1 also makes it possible to reduce the possibility that the access information is lost as in the example embodiment where the access information indicator 2 is provided on the outer packaging as described above. The present embodiment is therefore high in convenience in this regard.

When performing analysis of a sample using the reagent kit according to the present embodiment, a seal of the individual packaging 13 is broken to remove the reagent container 1 from the individual packaging 13. Then, the lid of the reagent container 1 is opened to take out the reagent using a member such as pipette, following which the reagent is placed into a measurement container to be utilized for analysis. The access information indicator 2 provided on the outer surface of the reagent container 1 is read as described above to download the measurement software. A detail of the code of the access information indicator and any other part of the present embodiment are similar to those described in the foregoing embodiment, and hence they will not be described in detail.

In each of the example embodiments described above, the access information indicator 2 may be the QR code. This allows for the access to the measurement software server 3 through reading the QR code using a camera provided in the client 4, which is extremely simple and less troublesome for a measurer. For example, it is not necessary for the measurer to input the access information manually, and each of the example embodiments described above is simple in this regard. Although the QR code is one example of an information code readable by a reader provided in the client 4, the access information indicator 2 may be any other two-dimensional symbol, or may be a one-dimensional symbol such as a barcode in one embodiment. The use of the two-dimensional code such as the QR code may be more suitable than the one-dimensional code, because the access information indicator 2 is used for downloading the measurement software and thus tends to have a long code (code including a large amount of information). In one embodiment where printed URL serves as the access information indicator 2, a measurer may input the URL to gain access to the measurement software server 3.

It is to be noted that the example embodiment where the access information indicator 2 is provided on the inner surface of the cover 12 of the outer packaging, or is provided on the outer surface of the reagent container 1 provided in the individual packaging 13, is advantageous in that only a purchaser of the reagent kit is allowed to download the measurement software.

The access information indicator 2 can be provided on an outer surface of the outer packaging illustrated in FIGS. 1A and 1B, or can be provided on an outer surface of the individual packaging 13 illustrated in FIGS. 6A and 6B. In this case, however, persons other than the purchaser of the reagent kit (such as a distributor or a dealer) are able to read the access information indicator 2 and to download the measurement software. To avoid such circumstances, the access information indicator 2 may be provided at a location where only the purchaser is able to see as described above, as with each of the foregoing example embodiments.

In an alternative embodiment, a configuration may be employed in which a seal for covering the access information indicator 2 may be attached to the access information indicator 2 when the access information indicator 2 is provided on the outer surface of the outer packaging. There may also be an embodiment where the access information indicator 2 does not have to be provided at a location only visible to a purchaser of the reagent kit, because downloading the measurement software holds no meaning unless there is an actual reagent. In such an embodiment, a configuration may be employed in which the access information indicator 2 is merely provided on the outer surface of the outer packaging or on the outer surface of the individual packaging. In either case, the reagent kit is provided with the access information indicator 2, making it possible for the purchaser of the reagent kit to gain access to the measurement software server 3, and thereby making it possible to achieve effects described above.

In each of the example embodiments described above, the access information indicator 2 is indicative of the access information that serves as the information for downloading the measurement software from the measurement software server 3. In an alternative embodiment, a configuration may be employed in which the measurement software is utilized on a server, like Application Service Provider (ASP) and Software as a Service (SaaS). In other words, the measurement software may be handled as a server side program, and a measurer may read the access information indicator 2 with the client 4 to execute the measurement program. This embodiment may be preferable in that, because the access to the measurement software server 3 is made each time the measurement is performed, monitoring of the number of measurements in which the reagent is used is possible, which allows for detailed understanding of usage of the reagent. However, reading the access information indicator 2 in every measurement is troublesome. Hence, it is preferable that the access information be copied upon the initial reading of the access information indicator 2, and a shortcut icon of an execution command of the measurement program be created on the client 4.

Also, in each of the example embodiments described above, the calibration curve data may be a constant embedded in the measurement program. A configuration in which the calibration curve data is handled as the constant and is passed as an argument upon execution of the measurement program is advantageous in terms of easier creation of software when a change is made only to the calibration curve data, as in the case of the measurement soft that corresponds to the additional production lot. Nevertheless, the calibration curve data may be embedded in the measurement program from the very start, when volume of the calibration curve data is small or when automatic embedding of the calibration curve data in the measurement program is possible, for example.

Further, in each of the example embodiments described above, absorption spectrophotometry is given as an example of the optical measurement in which a reagent is used, although the invention is not limited thereto. Any embodiment of the invention is applicable to various optical measurements in which a reagent is used. Non-limiting examples of such optical measurements may include fluorescence measurement, chromaticity measurement, and chemiluminescence measurement. As for the light source 53, non-limiting examples thereof may include a light-emitting diode (LED) and any standard light source, besides the laser light source as described above.

The measurement software server 3 may be the server that allows a developer to upload the software freely to a certain extent and allows a user to download the software with or without payment, or may be a dedicated server for distributing the measurement software. In an alternative embodiment, distribution of the measurement software may be performed based on a web server that offers information or service related to a reagent or the measuring device 5.

The measurement software server 3 may be developed as a single virtual server through connecting a plurality of computers. For example, in one embodiment, a so-called cloud computing technology may be used.

Furthermore, the invention encompasses any possible combination of some or all of the various embodiments described herein and incorporated herein.

It is possible to achieve at least the following configurations from the above-described example embodiments of the invention.

(1) A reagent kit, including:

a reagent to be used together with a measuring device in measurement of an optical characteristic of a sample;

one or more reagent containers containing therein the reagent; and

an access information indicator indicative of access information that allows a client to gain access to a measurement software server, the client being operated upon the measurement of the optical characteristic, and the measurement software server being a server on which measurement software is uploaded,

the reagent kit being provided for analysis of the sample through the measurement of the optical characteristic, and

the access information containing provider identification information that allows for identification of a reagent provider, the reagent provider being a provider of the reagent kit.

(2) The reagent kit according to (1), wherein the access information includes product serial information.
(3) The reagent kit according to (1) or (2), wherein the access information indicator includes an information code readable by a reader provided in the client.
(4) The reagent kit according to (3), wherein the information code includes a two-dimensional symbol optically readable by the reader.
(5) The reagent kit according to any one of (1) to (4), wherein the access information indicator is provided on the one or more reagent containers or an outer packaging, the outer packaging containing therein the one or more reagent containers.
(6) A measurement software server, including

a storage section on which measurement software is uploaded,

the measurement software server being configured to be accessed by a client through access information indicated by an access information indicator, the access information indicator being included in a reagent kit, the reagent kit being provided for analysis of a sample performed through measurement of an optical characteristic of the sample with use of a reagent and a measuring device, and the client being operated upon the measurement of the optical characteristic, and

the storage section storing therein provider identification information that is included in the access information and allows for identification of a reagent provider, and information that indicates that the access by the client through the access information is made, the reagent provider being a provider of the reagent kit.

(7) The measurement software server according to (6), wherein the storage section stores therein, as a database file, information in a form of database that includes the provider identification information and information indicative of date and time at which the measurement software is downloaded or executed by the access.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A reagent kit, comprising:
a reagent to be used together with a measuring device in measurement of an optical characteristic of a sample;
one or more reagent containers containing therein the reagent; and
an access information indicator indicative of access information that allows a client to gain access to a measurement software server, the client being operated upon the measurement of the optical characteristic, and the measurement software server being a server on which measurement software is uploaded,
the reagent kit being provided for analysis of the sample through the measurement of the optical characteristic, and
the access information containing provider identification information that allows for identification of a reagent provider, the reagent provider being a provider of the reagent kit.

2. The reagent kit according to claim 1, wherein the access information comprises product serial information.

3. The reagent kit according to claim 1, wherein the access information indicator comprises an information code readable by a reader provided in the client.

4. The reagent kit according to claim 3, wherein the information code comprises a two-dimensional symbol optically readable by the reader.

5. The reagent kit according to claim 1, wherein the access information indicator is provided on the one or more reagent containers or an outer packaging, the outer packaging containing therein the one or more reagent containers.

6. A measurement software server, comprising
a storage section on which measurement software is uploaded,
the measurement software server being configured to be accessed by a client through access information indicated by an access information indicator, the access information indicator being included in a reagent kit, the reagent kit being provided for analysis of a sample performed through measurement of an optical characteristic of the sample with use of a reagent and a measuring device, and the client being operated upon the measurement of the optical characteristic, and
the storage section storing therein provider identification information that is included in the access information and allows for identification of a reagent provider, and information that indicates that the access by the client through the access information is made, the reagent provider being a provider of the reagent kit.

7. The measurement software server according to claim 6, wherein the storage section stores therein, as a database file, information in a form of database that includes the provider identification information and information indicative of date and time at which the measurement software is downloaded or executed by the access.
